(19) United States
(12) Patent Application Publication
(10) Pub. No.: US 2016/0180360 A1
(43) Pub. Date: Jun. 23, 2016

(54) DEVICES, SYSTEMS AND METHODS FOR MANAGING FEEDBACK IN A NETWORK OF COMPUTING RESOURCES

(71) Applicant: EDATANETWORKS INC., Calgary (CA)

(72) Inventors: Terrance Patrick TIETZEN, Edmonton (CA); Matthew Arnold Macpherson BATES, Beaumont (CA); Michael J. KIMBALL, Stockton, CA (US); Kevin CATHRO, Edmonton (CA)

(21) Appl. No.: 14/973,918

(22) Filed: Dec. 18, 2015

Related U.S. Application Data
(60) Provisional application No. 62/093,812, filed on Dec. 18, 2014.

(51) Int. Cl. G06Q 30/02; G10L 13/027; G10L 13/04

(52) U.S. Cl. CPC G06Q 30/0203; G06Q 30/0201; G10L 13/043; G10L 13/027

(57) ABSTRACT

A network communication system for exchanging feedback data between merchant systems and cardholder devices. Cardholder devices receive and process speech signals for feedback requests and generate speech signals for feedback responses. A feedback component has a text to speech processor for generating the speech signals for the feedback requests using feedback request data records, and a speech to text processor for generating feedback response data records by transforming the speech signals for feedback responses. A notification management processor manages transmissions of the speech signals for feedback requests by determining, for each feedback request, a respective delivery notification delay.

### CROSS-REFERENCE TO RELATED APPLICATIONS

This application claims the benefit, including priority, of U.S. Provisional Patent Application No. 62/093,812, filed Dec. 18, 2014, and entitled “DEVICES, SYSTEMS AND METHODS FOR FEEDBACK”, the entirety of which is hereby incorporated by reference.

### FIELD

The improvements generally relate to the field of loyalty program network communication systems, and in particular, relate to devices, systems and methods for collecting feedback on merchant transactions from customers.

### INTRODUCTION

Loyalty program network communication systems may distribute and collect data relating to merchant transactions with customers that are members or cardholders of a loyalty program. The transaction data may detail transactions between the customer and the merchant including goods or services purchased, date, time, total cost, and so on. Loyalty program network communication systems may also enable merchants to provide communications to customers regarding transactions, including offers and rewards. It may be desirable for a merchant to solicit and receive feedback from customers regarding its transactions. There exists a need for improved feedback communications systems, or at least alternatives.

### SUMMARY

In accordance with one aspect, there is provided a network communication system for feedback that has one or more merchant systems. Each merchant system has a transaction processing device for triggering transmission of a transaction notification alert, and a location device for generating and transmitting location data for the one or more merchant systems. The network communication system has a transaction notification system for collecting transaction notification alerts from the one or more merchant systems and transmitting a transaction notification data feed compiling the collected transaction notification alerts. The network communication system has one or more cardholder devices configured to receive and process speech signals for feedback requests and generate speech signals for feedback responses, wherein the cardholder devices comprise location detection hardware for generating location data for the one or more cardholder devices. The network communication system has a feedback component that has a text to speech processor for generating the speech signals for the feedback requests using feedback request data records. The feedback component has a speech to text processor for generating feedback response data records by transforming the speech signals for feedback responses received from the one or more cardholders devices. The feedback component has notification management processor for managing transmissions of the speech signals for feedback requests by determining, for each feedback request, a respective delivery notification delay. The feedback component has a transceiver for transmitting and receiving the feedback request data records and the feedback response data records. The transceiver transmits a portion of the feedback request data records or the speech signals for feedback requests after expiration of the respective determined delivery delay in response to a location notification. The feedback component has a network interface for connecting to the one or more merchant systems, one or more cardholder devices and the transaction notification system for data exchange. The feedback component has location tracking hardware for correlating the location data for the one or more cardholder devices to the location data for the one or more merchant systems to generate the location notification to trigger the transmission of the speech signals for feedback requests. The feedback component has one or more data stores for storing feedback request data records and the feedback response data records.

In accordance with another aspect, there is provided a method for managing feedback communications in a network of computing resources. The method includes: receiving, by at least one processor, at least one transaction communication, the at least one transaction communication including data associated with an electronic transaction involving a payment identifier associated with a customer profile; initiating signals to cause a trigger handler to establish a trigger condition for initiating a feedback acquisition based on the data associated with the electronic transaction; and upon detection of the trigger condition, initiating signals to cause a input device to receive feedback input.

In accordance with another aspect, there is provided a non-transitory, computer readable medium or media having stored thereon computer-interpretable instructions. When executed by at least one processor, the computer-interpretable instructions configure the at least one processor for: receiving at least one transaction communication, the at least one transaction communication including data associated with an electronic transaction involving a payment identifier associated with a customer profile; initiating signals to cause a trigger handler to establish a trigger condition for initiating a feedback acquisition based on the data associated with the electronic transaction; and upon detection of the trigger condition, initiating signals to cause a input device to receive feedback input.

Many further features and combinations thereof concerning embodiments described herein will appear to those skilled in the art following a reading of the instant disclosure.

### DESCRIPTION OF THE FIGURES

In the figures,

FIG. 1 is a schematic view of an example network communication system for providing loyalty programs having a feedback component according to some embodiments;

FIG. 2 is a flowchart view of a method for feedback according to some embodiments;

FIG. 3 is a schematic view of a feedback component used to implement the method of FIG. 2 according to some embodiments;

FIG. 4 is a schematic view of a customer device and merchant system according to some embodiments;

FIG. 5 is a schematic view of a data store of records for the feedback component according to some embodiments.

### DETAILED DESCRIPTION

Embodiments described herein relate to methods and systems for managing feedback communications in a network of computing resources.

In some instances, some embodiments may provide a system which, through feedback communication signals, may obtain timely feedback triggered by an interaction between two or more devices or systems. In some instances, some embodiments may provide for technical mechanisms by which feedback inputs may be received and/or reviewed. Some such mechanisms may improve the ease with which feedback signals can be received/reviewed and may, in some instances, increase the likelihood that feedback will be captured/reviewed and/or increase the relevance of the feedback based on the proximate time of its collection.

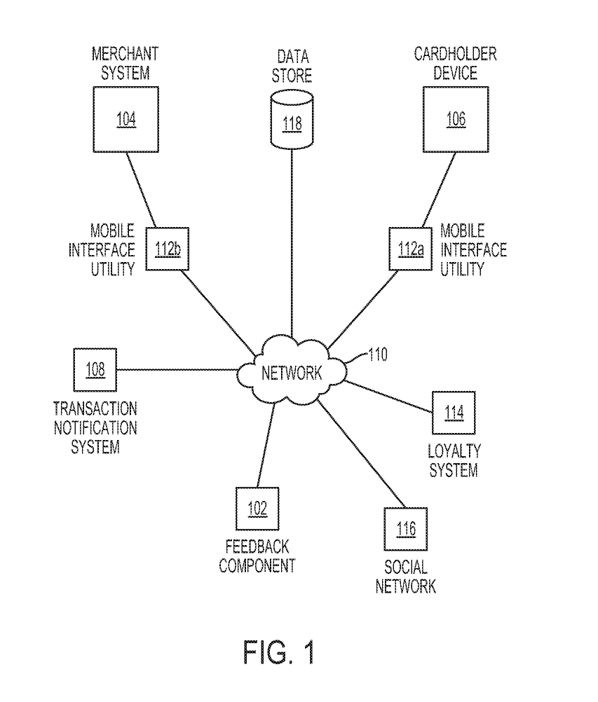

FIG. 1 illustrates a network communication system 100. System 100 may include a feedback component 102, one or more merchant systems 104, one or more cardholder devices 106, and a transaction notification system 108. System 100 also includes loyalty system 114 for providing loyalty programs according to some embodiments. System 100 further includes a mobile interface utility 112a connecting one or more cardholder devices 106 to feedback component 102 via network 110, and a mobile interface utility 112b connecting one or more merchant systems 104 to feedback component 102 via network 110.

A customer and a merchant conduct a transaction for goods or services. The customer may be a consumer or member or cardholder of a loyalty program, and may be referred to herein as a cardholder. A feedback component 102 delivers a feedback request to the cardholder device 106 at a time based on dynamic delivery delay period. There may be a delivery delay for the transmission of the feedback request for convenience to the cardholder and to increase likelihood that the cardholder will respond to the feedback request. The time period of the delivery delay may be calculated based on various transaction data factors, such as for example the type of transaction, the type of good or service, customized preferences, and so on. The time period may be proximate to the transaction time, or may be hours after, depending on various factors. For example, if the transaction relates to golf the delivery delay may be for a time period such as an average round of golf or an event such as the cardholder being located at their vehicle to wait until after they finished golfing and experienced the golf course or used a purchased club.

Accordingly, a time period on the occurrence of a location event may trigger delivery of the feedback request.

While the example feedback component 102 in FIG. 1 is illustrated separately, in some embodiments, one or more aspects of the feedback component 102 may be part of a merchant system 104, a loyalty system 114, a transaction notification system 108, a cardholder device 106, or any other device or system in the network. In some examples, the feedback component and its functions may be implemented by any number of processors, applications, devices and/or systems at any location and/or distributed across the network.

In other embodiments, the systems 102, 104, 106, 108, 114, 116 and their functions of the may be distributed in any suitable manner and across any topology or arrangement of computing devices/resources.

The feedback request may request additional data from the cardholder regarding the transaction over and above the transaction details. For example, the request may be for rating indicia to rate the transaction experience, the merchant, the goods or services, and so on. As a further example, the request may be for answers to questions about the transaction, merchant, goods or services, bank, card issuer, loyalty program, purchase decision, and so on.

The feedback request may be a voice feedback request. A feedback request may be delivered to a cardholder device 106 as speech signals, or in a format that may be converted by the cardholder device 106 into speech signals. The cardholder device 106 may have a text to speech processor to transform text data into speech signals. In other embodiments, the cardholder device 106 may receive the feedback request as speech signals.

In response to the feedback request, feedback response data may be generated at the cardholder device 106. The feedback response may be a voice feedback response. Feedback response data may be generated at the cardholder device 106 by transforming speech signals received at the cardholder device from utterances by the cardholder. The voice feedback response may be converted into text data for storage and retrieval. The voice feedback response may also be stored as audio or video signals. The feedback response may be saved in a data store separate from the cardholder device 106. This may be helpful if the cardholder wants to access feedback response(s) but misplaces their device or deletes local data on their device relating to the feedback response. This may be helpful if cardholder device has limited memory resources or if cardholder would like to use a different device to access feedback data. In addition, the stored feedback responses may be provided to merchant system 104 for access and review. In some example embodiments, the feedback responses may be provided to merchant system 104 in a way that provides anonymity to the cardholder that the feedback was received from.

Feedback component 102 connects to cardholder device 106 via network 110. Network 110 is capable of carrying data may include the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WMAX), SS7 signaling network, fixed line, local area network, wide area network, and others, or a combination of these.

Loyalty system 114 provides a loyalty program for cardholders and merchants, where the loyalty program facilities feedback on transactions. Loyalty system 114 may be an automated cause marketing (“ACM”) program with a fundraising component. An ACM program automates dissemination of benefits to several parties involved in fundraising, including one or more supported organizations (for example, charities), merchants, and cardholders (also referred to as customers, members, consumers). Flow-through to the supported organizations may be maximized in the ACM model.

A cardholder may be attracted to and join an ACM program based on particular supported organizations involved. For example, a particular cardholder may favor an ACM program that benefits supported organizations with which the cardholder has an emotional bond. The cardholder may often prefer to transact with merchants registered with the ACM program rather than those not registered with the ACM program so as to benefit these supported organizations.

Loyalty system 114 targets the emotional bond a cardholder might have with particular merchants. Many cardholder favor particular merchants, such as local or regional businesses that are “institutions” in their communities. These local and regional businesses are often referred to as “mom and pop stores”, illustrating the familial connection felt by their customers.

These local and regional businesses may not have in-house systems or an electronic interface integrated with outside third party systems. They may not have had any opportunity to integrate their merchant systems 104 into a loyalty system 114 for providing loyalty programs such as ACM programs. It is often this same type of business that may tend to favor donations to supported organizations with which they also have an emotional bond, so cardholders may not have necessarily been fully incentivized to join ACM programs. These cardholders may be more likely to participate in an ACM program if the local or regional business is tied to the loyalty program.

It may be challenging to incorporate these types of merchants and supported organizations into current ACM programs, for example, due to significant costs associated with providing the communication infrastructure required by such programs, and difficulty with data integration and consistency for a large number of different merchant systems 104 operating independently. Loyalty system 114 provides integration with different of merchant systems 104 to customize feedback requests.

Cardholders may also be more likely to respond to feedback requests and surveys about the merchants for a loyalty or ACM program provided by loyalty system 114 if the feedback requests are received in a timely manner using a convenient delivery process.

Feedback component 102 may transmit feedback requests in the form of speech signals to cardholder devices 106 via mobile interface utility 112a. In response, feedback component 102 may receive speech signals for feedback responses from cardholders devices 106 for processing and storage. Feedback component 102 may determine, for each feedback request, a respective delivery notification delay and transmit a feedback request after expiration of a determined delivery delay time period, or occurrence of a trigger event. The delivery notification delay may be based on a dynamic time period that varies with transaction, good or service, or the delivery notification delay may be based on the occurrence of an event. The delivery notification delay may be trigger by an event such as a location event where cardholder device 106 is detected at a specific location. Another event may be a vehicle is detected to turn on or the detection of a cardholder at an associated merchant location.

Feedback component 102 may receive data for feedback requests from the merchant systems 104 via mobile interface utility 112b, and may generate and transmit reports of the feedback responses to merchant systems 104. Feedback component 102 may form part of a loyalty program managed by loyalty system 104. Feedback component 102 may store feedback requests and feedback responses, along with related transaction, merchant and cardholder data in data store 118. The stored data may be subsequently accessed from data store 118 by feedback component 102, merchant system 104, cardholder device 106, and other component. Feedback component 102 may connect with a social network platform 116 to distribute data for feedback requests and feedback responses to cardholders.

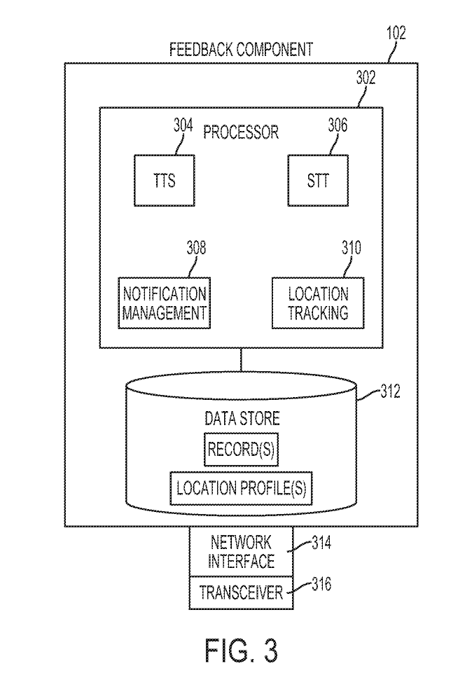

Feedback component 102 may include location tracking hardware for correlating location data for the cardholder device(s) 106 to the location data for merchant system(s) 104 to generate location events and trigger the transmission of feedback requests. Feedback component 102 may be connected to other components via a network 110 in a cloud computing configuration. Feedback component 102 may be part of loyalty system 114. Feedback component 102 will be described in detail herein in relation to FIG. 3. For simplicity only one feedback component 102 is shown but there may be multiple feedback components 102.

Transaction notification system 108 connects to a transaction data provider to receive data feed notifications indicating when new transactions occur between customers and merchants. Transaction notification system 108 includes at least one processor, at least one data storage device, and at least one communication interface as described herein. Only one transaction notification system 108 is shown for simplicity but there may be multiple interconnected systems.

Merchant system 104 may include various connected hardware devices. For example, merchant system 104 may include at least one processor, at least one data store, at least one network communication interface, a transceiver for transmitting feedback request related data, and for receiving feedback response related data such as a feedback report, for example. A merchant may use the merchant system 104 to process transactions with customers, provide feedback request related data, and receive feedback response related data.

Merchant interacts with merchant system 104 to access the functionality of feedback component 102. Merchant system 104 may include one or more hardware components such as a processor, data store, communication interface, and transaction device including point of sale device, NFC device, code reader, or other device for processing transactions. Merchant system 104 may include one or more software components, such as a loyalty application, transaction firmware, and so on. Merchant system 104 may connect to the core feedback component 102 via a network, such as for example one or more public or private networks for an online mode. Merchant system 104 may also feature an off-line mode.

Cardholder device 106 may include various connected hardware communication devices, such as a mobile device, onboard vehicle system, and so on. For example, cardholder system 106 may include at least one processor, at least one data store, a transmitter for transmitting feedback response related data, and a receiver for receiving feedback request related data, for example. Cardholder device 106 may include one or more input devices, such as a keyboard, mouse, camera, touch screen and a microphone, and may also include one or more output devices such as a display screen and a speaker.

Cardholder device 106 is operable by a cardholder (also referred to as customers, members, consumers). A cardholder may be a member of a loyalty program (managed by loyalty system 114) with an associated card. The cardholder may also be a member of a financial service with an associated card, such as a transaction card such as a credit card, debit card, stored value card and so on. The card may be a virtual card stored on a mobile device as transaction tokens in other example embodiments. The card may include machine readable indicia stored in a local data store. The cardholder device 106 may also include a radio-frequency identification (RFID) device, or other near-field communication (NFC) device to exchange data with a merchant system 104, for example.

A cardholder device 106 may implement transaction and feedback operations using tokens, in some embodiments. A token may be used with a physical device that identifies and authorizes a cardholder for specific actions relating to the transaction and the feedback. The token may store temporary or permanent cardholder identification data, financial data, cryptography keys, digital signature, biometric data, and so on. There may be additional types of authentication required, such as PIN, password, and so on. A token may be used with a dedicated hardware device, secure element, or secure component. A token may be associated with a configuration file to define data fields associated with the token. The token may be encrypted for additional security.

The cardholder may use cardholder device 106 to transact with merchants using tokens, receive feedback request related data, and provide feedback response related data. Customers interact with cardholder device 106 to access the functionality of feedback system 102. As noted, cardholder device 106 may include one or more hardware components such as a processor, memory, display (e.g. touch display), mobile phone components, NFC device, location device, secure transaction token data store, and so on. Cardholder system 106 may form part of a vehicle on-board system. Cardholder device 106 may include one or more software components, such as a loyalty application, transaction firmware, and so on. Cardholder system 106 may connect to the core feedback component 102 via a network 110, such as for example one or more public or private networks for an online mode. Cardholder system 106 may also feature an off-line mode.

In accordance with some embodiments, cardholder device 106 may include voice capabilities. For example, cardholder device 106 may include a text to speech processor for transforming text based data into speech signals. Cardholder device 106 may also include a speech to text processor for transforming speech utterances into text based data. As noted, cardholder system 106 may also include input/output devices, including a video device and an audio device.

Mobile interface utility 112a connects one or more cardholder devices 106 to feedback component 102 via network 110, and mobile interface utility 112b connects one or more merchant systems 104 to feedback component 102 via network 110.

Mobile interface utility 112a/b is operable to interface with mobile devices used to implement at least a portion of one or more cardholder devices 106 and merchant systems 104. Mobile interface utility 112a/b may enable optimal transacting between the feedback component 102 and one or more cardholder devices 106 and merchant systems 104 to provide real time location driven feedback requests. These features may enable increased feedback opportunities for merchants by, for example, increasing cardholder awareness of merchant feedback requests, increasing feedback and survey responses through timely feedback requests, and increasing ease of use by cardholders using a customized delivery delay when requesting feedback.

The mobile interface utility 112a /b may augment the typical usage of the ACM program by leveraging a mobile network (which may form part of network 110 of FIG. 1), along with location based triggers and time based triggers for feedback requests. In addition, a cardholder may conveniently provide a feedback response by means of the cardholder device 106.

The cardholder may customize the communications received and sent through their cardholder device 106. For example, a cardholder may define a list of preferred merchants where features associated with the mobile device utility 112a/b are only operable in association with merchant systems 104 within the preferred merchants list. The list may be defined within the ACM program either using a web interface or on a mobile device interface of the ACM program, after completing an authentication process. Upon authentication, a list of merchants may be displayed to a cardholder via cardholder device 106. A searching means could also be provided to the cardholder to search for merchants by name, category, location, or other criteria. The cardholder may add merchants using either the list or the searches. A link may also be provided to the current preferred merchants list on the cardholder device 106. The cardholder may be provided with a means to delete one, some, or all of the merchants on the list so they are no longer preferred merchants. Alternatively, the cardholder may add or delete a merchant on the list upon receiving an offer, reward, feedback request, or contest from the merchant on the cardholder device 106. Furthermore, the cardholder may customize the types of communications to be received from each preferred merchant. Additionally, when offers, rewards, feedback requests (e.g. surveys, questionnaires), or other communications are received on the cardholder device 106, a cardholder may associate its corresponding merchant system 104 with the preferred merchants list or remove it from the preferred merchants list. The cardholder could also block a particular type of communication from that merchant using the preferred merchants list. Features may be limited to the preferred merchants or may be operable for all merchants depending on the particular ACM program implementation and the cardholder's preferences. Features may similarly be limited to merchants offering particular types of goods or services, or by any other type of categorization. Furthermore, the mobile device utility 112a may be provided with a means allowing a cardholder device 106 to determine which features to enable/disable.

Full access to the ACM program features may be provided using the cardholder device 106. For example, an ACM program available through the internet may make available a simplified interface, or the ACM program interface, to be viewed on a cardholder device 106.

The cardholder may effect a search for offers and rewards and be introduced to a merchant (associated with merchant system 104) through an offer or reward. Upon transacting with the merchant system 104, the cardholder device 106 need only display the offer on the display screen, rather than have to print a coupon or other offering means. For example, a bar code may be displayed on the display screen of the cardholder device 106.

The mobile device utility 112a may also enable real time delivery of feedback requests, such as a survey or questionnaire, after a transaction between the cardholder and a merchant. The mobile device utility 112a may present the feedback request to the cardholder device 106 at a convenient time using the delivery notification delay. The cardholder device 106 may provide the feedback response immediately or soon after the initial feedback request. The cardholder can complete the feedback response on their cardholder device 106 at a time approximate the transaction based on the delivery delay. The mobile device utility 112a/b may provide a voice feedback request by converting text based data into speech signals, and may process a voice feedback response received as speech signals into text based data, or other format. The mobile device utility 112a/b may therefore enhance the ease of the feedback process, timeliness of delivery, format conversions, and so on.

The transaction may also result in a cardholder being provided with a gift card in accordance with the rules of the ACM program. If the gift card requires activation, the mobile device utility 112a could be used by the cardholder device 106 to activate the gift card. The cardholder may input the gift card number and optionally be provided with a feedback request (e.g. survey, questions) which, when completed by way of a feedback response, activates the gift card. A confirmation message may be sent to the cardholder device 106.

The mobile device utility 112a/b may enable other aspects of the ACM program to be directed to the cardholder based on the location of the cardholder device 106. For example, the mobile device utility 112a/b may provide content such as rewards, offers, contests, and surveys, in accordance with its rules, to the cardholder device 106 when proximate to one or more merchants. For example, the ACM program may provide to the cardholder device 106 a list of contests that the cardholder can participate in. The cardholder may select the particular contest to participate in. The ACM program may require the cardholder to complete a survey or other feedback request to enter the contest. The cardholder may complete the survey by way of providing a feedback response, enter the contest, and the ACM program may send a confirmation message to the cardholder device 106.

Furthermore, a cardholder may, on the cardholder device 106, search, receive, and redeem rewards and special offers for a merchant. For example, the cardholder may navigate to and authenticate with the mobile ACM program and be provided with a link to rewards. The cardholder device 106 may provide location data such as GPS coordinates, a postal code/zip code, telephone area code, or other location defining information, and be provided with a list of nearby merchants offering rewards. The cardholder device 106 can browse the rewards and save rewards of interest. Saving a reward may result in downloading the reward details to a local storage means of the cardholder device 106. The reward details may include a bar code to scan at the merchant's point of sale. A cardholder may access their saved rewards at any time, but the rewards may be removed from cardholder device 106 once they are used by a cardholder, if the reward is to be so limited. As another example, the cardholder may access and authenticate with the mobile ACM program and be provided with a link to search rewards based on merchant name and optionally a radius. The ACM program may provide results for a named merchant or a number of merchants within a defined radius of the named merchant. Use of the reward may trigger a feedback request.

A cardholder that has previously been offered a reward from a particular merchant may, when the cardholder device 106 is near or proximate the location of the merchant, the reward details may be automatically downloaded to the cardholder device 106 so that the reward can be redeemed at the merchant location. Alternatively, a cardholder device 106 may be at a location that the cardholder is aware is near a merchant. The cardholder may use the mobile device utility 112a/b to search for special ACM offers available with the particular merchant. If special offers are available, the cardholder may be more likely to transact with the merchant at that particular time. For example, the cardholder may access and authenticate with the mobile ACM program and be provided with a link to search merchants for rewards based on merchant name. The cardholder may optionally filter the search by business category or minimum contribution percentage. The ACM program may provide a link to view the merchant's location and rewards as well as contribution information relating to the cardholder's transactions at the merchant. The cardholder can browse the rewards and save rewards of interest. Saving a reward may result in downloading the reward details to a local storage means of cardholder device 106. The reward details may include a bar code to scan at the merchant's point of sale. Use of the reward may trigger a feedback request.

The mobile device utility 112a/b may also enable a cardholder device 106 to disseminate feedback responses via social network platform 116. Social networking sites typically focus on building online communities of people sharing interests and activities, or who are interested in exploring the interests and activities of others. Embodiments described herein provides a means by which to expand the reach of feedback to cardholders' social networking contacts.

In accordance with some embodiments, system 100 may include a social network platform 116 for distributing feedback related information. A social media adapter utility may determine whether a cardholder device 106 has provided the necessary information to enable a link to that social network 116 and, if so, the social media adapter utility may post a feedback response on the cardholder's social network web page. Alternatively, if the information is not present, the social media adapter utility may request the information from the cardholder and then disseminate the information. Optionally, the cardholder may be required to confirm the posting when they next log in manually to the social network, as might be dictated by rules of the social network. Similar techniques may be used to disseminate surveys, events, and contests to the social networks. A cardholder may also disseminate information regarding its contribution statistics. The cardholder may access this information using analytics provided by the ACM program. Similarly, the cardholder could disseminate any other information provided by the ACM program.

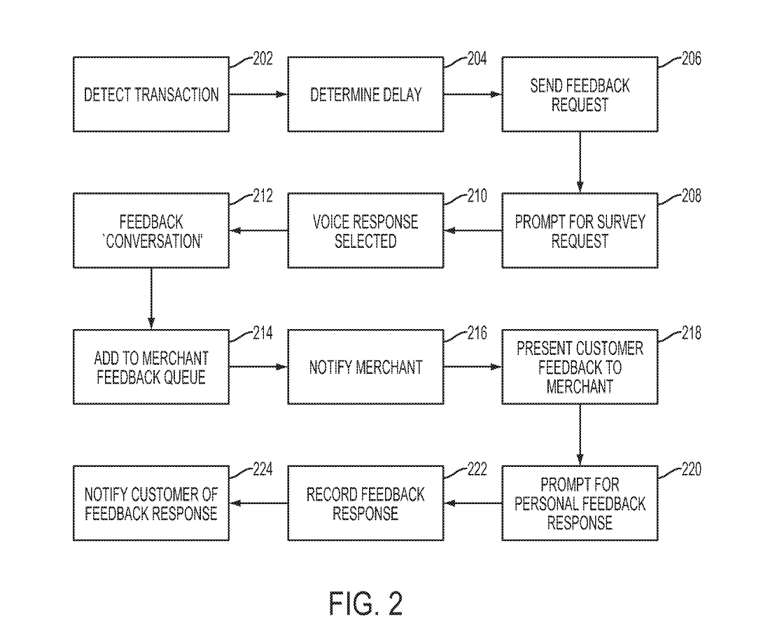

FIG. 2 illustrates an example method 200 for feedback according to embodiments described herein. FIG. 3 illustrates a schematic of feedback components 102 used to implement the method 200.

As shown in FIG. 3, feedback component 102 may include a feedback processor 302, network interface 314, a data store 312 (including volatile memory or non-volatile memory or other data storage elements or a combination thereof) of feedback request records and feedback response records, and a transceiver 316 for transmitting feedback requests and receiving feedback responses. The computer hardware of feedback component 102 may be connected in various ways including directly coupled, indirectly coupled via a network, and distributed over a wide geographic area and connected via a network in a cloud computing configuration.

Feedback component 102 may serve multiple users. Feedback component 102 is operable to register and authenticate cardholder devices 106 (using a login, unique identifier, password, and token exchange, for example) prior to providing access to feedback requests and receiving feedback responses. A feedback response may include an authentication token (via cardholder device 106) for use by feedback component 102 to authenticate a feedback response and link the feedback response to a respective cardholder device 106.

In some embodiments, registration of a cardholder device comprises creating/completing a customer profile, or otherwise providing a database which links a cardholder device 106 to the customer profile. In some examples, this link includes storing a device identifier such as a MAC (media access control) address, phone number, SIM (subscriber identification module) identifier, loyalty program unique identifier, or any other identifier or information suitable for use in identifying and/or contacting the cardholder device.

In some embodiments, registration can include linking one or more payment identifiers associated with a payment mechanism to the customer profile. In some examples the payment identifiers can include credit/debit card numbers, financial account numbers, and/or derivatives or tokens of such payment mechanisms. In some examples, the payment identifiers enable the feedback component, transaction notification system or other aspects of the network to associate transaction data with the customer profile.

The registration and accessing of cardholder devices and their associated payment identifiers can be managed by the feedback component, merchant system, transaction notification system, loyalty system, and/or any combination thereof or interaction between them.

For example, and without limitation, feedback component 102 may be implemented using one or more of a server, network appliance, dedicated appliance, embedded device, computer expansion module, personal computer, laptop, personal data assistant, mobile device, smartphone device, tablet, video display terminal, and other computing device capable of being configured to carry out the methods described herein.

Feedback processor 302 includes at least one processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Feedback component 102 may include computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Feedback processor 302 implements a text to speech processor 304, speech to text processor 306, notification management component 308, and a location tracking component 310.

Text to speech processor 304 is configured to generate the speech signals for the feedback requests using feedback request data records. Feedback component 102 transmits the feedback requests to cardholder device(s) 106 after a determined delivery notification delay. Text to speech processor 304 is configured to interact with data store 312 to retrieve text data (e.g. feedback content data) of feedback request data records for conversion into speech signals.

Speech to text processor 306 is configured to generate feedback response data records by transforming the speech signals defining feedback responses received from the cardholders devices 106 into text data defining feedback responses. Speech to text processor 306 is configured to interact with data store 312 to store the text data defining feedback responses as feedback response data records.

Notification management processor 308 is configured to manage transmissions of the speech signals for feedback requests by determining, for each feedback request, a respective delivery notification delay. The delivery notification delay may be based on time trigger or an event trigger. For example, a delivery may be triggered when a cardholder arrives at vehicle after the transactions.

Network interface 314 is configured to connect to merchant systems 104, cardholder devices 106, and the transaction notification system 108 for data exchange.

Transceiver 316 is configured to transmit and receive the feedback requests and the feedback responses. Transceiver 316 is configured to transmit a portion of the feedback request data records or the speech signals for feedback requests after expiration of the respective determined delivery delay or in response to an location event. The delivery notification delay triggers transmission of the feedback request.

Feedback component 102 has a network interface 314 in order to communicate with other components, to exchange data with other components, to access and connect to network resources, to serve applications, and perform other computing applications by connecting to the network 110 (or multiple networks).

Location tracking component 310 includes hardware configured to correlate the location data for cardholder device(s) 106 to the location data for the merchant system(s) 104 to generate a location notification that a cardholder device 106 is proximate to a merchant system 104, such as within a merchant store, in the parking lot of a merchant store, or within a defined distance of a merchant store, and so on. The location notification event may trigger the transmission of the speech signals for feedback requests to cardholder device(s) 106.

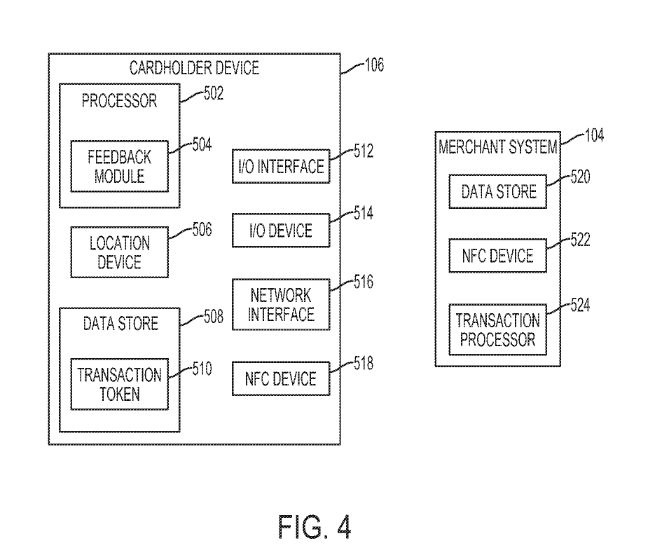

Cardholder devices 106 may be equipped with means for location tracking (e.g. location device of FIG. 4), such as a global positioning system (GPS). Where a particular cardholder device 106 is equipped with GPS, various location based and proximity based data may be provided to location tracking component 310 to build a location profile for a particular cardholder device 106. The location profile may be stored in data store 102 and updated by location tracking component 310 as additional location data is received from cardholder device 106. Each cardholder device 106 may have a corresponding location profile, or each cardholder associated with one or more cardholder devices 106 may have a location profile. Similarly a merchant system 104 may be associated with a location profile for one or more stores or locations. The merchant system 104 may also be mobile device with a location device to determine a current location and transmit the current location to location tracking component 310. Location based and proximity based feedback services may be provided.

For example, a mapping feature could be provided to a cardholder device 106 so that the cardholder could be given the location of a number of nearest merchants, or a number of nearest merchants offering a particular type of good or service, or the nearest preferred merchant. In addition, offers for nearby merchants could be sent to the cardholder, or in-store communications could be provided to cardholders in association with content including offers, rewards, contests or other announcement. Optimally, the content may be delivered to the cardholder's mobile device at approximately the time the cardholder enters the store, comes within a particular distance of the store, or passes directly in front of the store. The content may include any type of data including text, rich text such as HTML, audio, video, or images. The content could be for any purpose, including advertising a sale, or for highlighting a specific manufacturer or a specific product.

Correspondingly, a merchant could access through the ACM program interface a mapping feature displaying cardholders that are nearby. The merchant could then target rewards or otherwise attract those cardholders to the merchant location.

Further still, the cardholder could search for rewards or offers corresponding to all nearby merchants. The nearby merchants could also be selected based on past searches performed by the cardholder, such that the merchant could be one that sells goods or services previously sought by the cardholder. Merchants could also tailor the particular offers based on the cardholder's transaction history with the particular merchant or the transaction history of the cardholder with the ACM program generally, or with merchants in the same general field of sales as the particular merchant.

FIG. 2 illustrates an example method by feedback component 102. At 202, feedback component 102 detects a transaction between customer X and merchant Y. Transaction notification system 108 transmits a transaction notification data feed to feedback component 102 for processing to identify specific transactions. The transaction processing and detection may be real-time processing or batch processing, for example.

In some examples, the transaction communication can include data associated with an electronic transaction. This data can include, for example, a payment identifier associated with a customer and/or payment mechanism, a merchant identifier, a point of sale terminal identifier, and a transaction time. In some examples, a mobile communication device associated with the customer can be used in the transaction (e.g. via a mobile wallet or payment application) and may communicate a payment identifier such as a unique token to the merchant system.

In some examples, transaction notifications can include multiple transaction communications from any number of devices.

In some examples, the data includes identifiers or information for determining a location of a merchant. For example, the data can include an address, or an identifier with which an address can be determined from a location device such as a merchant, terminal or other database in the network. In some examples, a point of sale terminal or other device associated with the merchant system may include a location device such as a GPS or assisted-GPS system which can provide location data with a transaction communication. In another example, a device associated with the merchant system can communicate location data stored on the device (e.g. a manually inputted address stored in memory). In another example, location data can be based on a network to which the merchant device is connected (e.g. using an IP address).

In some examples, data included in transaction communication(s) can include information for identifying a good or service associated with the transaction, or a class of goods/services associated with the transaction. For example, the data can include a merchant category code and/or identifiers associated with specific products (e.g. an SKU / barcode).

The feedback component can identify a mobile communication device associated with the transaction based on the payment identifier. In some examples, the payment identifier may be cross-referenced with customer profiles to identify a mobile communication device. In other examples, the mobile communication device may communicate a payment identifier such as a token to the feedback component via a loyalty program, payment application or other application running on the mobile communication device.

At 204, upon receipt of the transaction communication(s), the feedback component 102 initiates signals to cause a trigger handler to establish a trigger condition (e.g. determine a delay based on time/location) which when satisfied can trigger a feedback acquisition process. This trigger condition can be based on the data associated with the electronic transaction. In some examples, the feedback component can initiate signals which instruct a trigger handler on a mobile device associated with the payment identifier in the transaction communications.

In other examples, the feedback component can initiate signals which configure a trigger handler at the feedback component to establish and monitor for the trigger condition.

In some examples, the trigger condition can be location-based, time-based, transaction-based, any other suitable condition or some combination thereof.

For example, in some embodiments, the trigger condition be established so that it is satisfied when the mobile communication device associated with the transaction leaves a location associated with the transaction.

The mobile communication device may generate signals indicating the mobile communication device is located at a particular location (e.g. via GPS, a-GPS or other location device), or is travelling or accelerating a particular speed/acceleration. In some embodiments, the mobile communication device can generate signals indicating the mobile device has paired with a vehicle system or other device that is likely away from a location of the merchant (e.g. via Bluetooth™). In some embodiments, the mobile communication device can generate signals indicating the mobile device has been plugged in or otherwise connected to an electric charger (which may indicate that the device holder is stationary and/or is away from the merchant location).

In some examples, the mobile communication device can generate signals indicating the mobile device has activated a transportation or map/navigation application (e.g. Google™ Maps, Uber™, public transit application, any application which accesses location features), or has paid for a transit fare (e.g. bus/train fare).

In some embodiments, the trigger handler is operating on the mobile communication device and monitors whether any trigger condition(s) are met based on the location-related signals generated by the mobile device.

If the trigger handler is operating on a remote feedback component, the mobile communication device can transmit the location-related signals to the feedback component for monitoring.

In some examples, trigger conditions can include any one or more of: the mobile device has paired with a vehicle or an electric charger (wired or wireless), the mobile device has accessed a transportation or map/navigation application, or has paid for a transit fare.

In some examples, trigger conditions can include any one or more of: whether a mobile device location is outside a defined distance of a location associated with the transaction (e.g. a distance indicating the customer has left the merchant store), or whether the mobile device is travelling or accelerating at a rate over a defined threshold (e.g. speed / acceleration commonly associated with a vehicle).

In some examples, the trigger conditions can be specific to a merchant, a location, a transaction type, etc.

In some examples, the trigger conditions can be additionally or alternatively based on a time delay.

For example, establishing the trigger condition can include determining an appropriate notification delay or delivery delay for sending the feedback request to the cardholder device 106 associated with the transaction. The delay period may depend on the good or service, customer device preferences, the location of the cardholder device 106 (e.g. GPS location), the location of the merchant system 104, the merchant system 104, and so on. The delay may be customized and linked to a merchant record, good record, service record, card holder record, or a combination thereof. The delivery delay time period may be dynamically determined at the time a transaction notification is received. Accordingly, the delay may be based on the proximity of the location between the cardholder device 106 and the merchant system, or other delay factors such as time of day.

The delivery delay time period may be dynamically determined based on historical data about feedback response, such as average response time, most frequent time feedback responses are received, and so on. In some examples, feedback history and timing data can be stored in a customer profile.

As an illustrative example, for a service such as an oil change store, the delay period may be short proximate to completion of the transaction when the user is back in vehicle. For a casual dining establishment, a delay period of a few minutes may be used to allow for the customer to exit the restaurant, for example. For a golf course, a delay of 5 hours may be utilized to permit the golfer to complete their round before being prompted for feedback response data. As a further example, for a golf establishment purchase of a product from the pro-shop may trigger a feedback request shortly after the purchase time, whereas the purchase of a round of golf may trigger a feedback request after five hours from the purchase time to allow for completion of the round of golf prior to feedback.

In some examples, the feedback component can monitor and store historical trigger condition times for a particular customer, merchant and/or transaction type (e.g. class or particular good/service) to obtain an typical delay time for the particular customer, merchant, transaction type or combination thereof. This typical delay time can be stored and used to establish subsequent trigger conditions.

At 206, feedback component 102 sends a feedback request to cardholder device(s) 106 associated with the customer's loyalty system account. The request may include details of the transaction such as the good or service. Feedback component 102 considers the determined delivery delay period prior to transmitting the feedback request.

The feedback request may be dynamic based on historical feedback response data from the cardholder device 106, or other cardholders. For example, a format and number and type of question to ask may depend on past response rates to increase likelihood of response.

At 208, on the cardholder device 106, the feedback request may prompt the customer to complete a survey about their experience, and asks the user to specify how they want to provide their opinion. Options may include by voice, by video, typing, and so on. Also provided are the options to postpone feedback (e.g. remind me later), or to ignore the feedback request.

At 210, the cardholder device 106 receives a speech signal input command. The command may be a feedback response. The exchange of feedback requests and feedback response may continue. The content may be dynamic as a result of feedback responses to feedback requests.

At 212, using voice audio and/or on-screen prompts, an application on the cardholder device 106 initiates a ‘feedback conversation’ with the customer as a series of speech signals processed to generate feedback responses. During the conversation, the system 100 uses speech analysis and optionally emotion-detection to analyze the speech signals for feedback responses, and to help determine the next appropriate operation (e.g. transmit additional feedback requests and the content of the feedback requests).

The feedback conversation may include a short survey set of questions and requests. For example, a cardholder answers premade questions or the alternative, general feedback request prompt with a “General Comment” style survey request.

Consider the following example data exchange: A feedback request may involve speech signals defining a survey question such as “With a rating of one to five, five being the best, how was your experience at [business name]?” A feedback response from the cardholder device 106 may be “two”. An additional dynamically determined feedback request may involve speech signals “Sorry to hear that. Why was it only a two?” An additional feedback response from the cardholder device 106 may be “The new server spilt a tray of drinks on my date, she was very upset.” A further additional dynamically determined feedback request may involve speech signals “Got it. I want to get this to management, is this something you want them to hear right away?” An additional feedback response from the cardholder device 106 may be “Yes” A dynamically determined feedback request may involve speech signals “Sending it now. Would you like to request a personal response from them?” An additional feedback response from the cardholder device 106 may be “Yes” Another dynamically determined feedback request may involve speech signals “Ok, I'll let them know. Thanks for your feedback.”

Having received the speech signals defining feedback responses, at 214, the loyalty system 10 stores data in a persistent data store and adds this feedback data to a feedback queue for the merchant system 104. The feedback queue provides a summary of received feedback responses for merchant system 104 to generate reports, initiate action, etc.

The feedback components 102 may include speech processing hardware to transcribe the audio ‘conversation’ into a text representation, or deliver a portion of the feedback request as text data. This may enable a customer to efficiently scan a list of feedback questions and respond to only a subset of interest.

An emotion detection engine may also be used to provide clues into the customer's demeanor and context. The emotion detection engine generates an emotional measurement of the feedback response, and may determine a tone or context for the feedback response. For example, the emotion detection engine may determine emotion(s) associated with feedback audio used a trained neural network, support vector machines (SVM), decision trees, and the like (see for example, Yacoub et al., Recognition of Emotions in Interactive Voice Response Systems, presented at Eurospeech 2003, 8th European Conference on Speech Communication and Technology, 1-4 Sep. 2003, Geneva, Switzerland).

Emotion detection engine detects emotion related to the feedback response and includes data defining the detected emotion as metadata for the feedback response record. Feedback component 102 may provide the data defining the detected emotion to merchant system 104 to evaluate how to respond to the cardholder associated with the feedback response. Feedback component 102 may automatically recommend an action for the merchant system 104 based on the detected emotion of the feedback response.

Emotion detection engine may detect a positive mood or emotion or context for feedback response. Feedback component 102 may provide data indicating the positive detected mood to merchant system 104. This may enable merchant using merchant system 104 take advantage of detected positive moods to encourage purchasing by the cardholder. Feedback component 102 may use the detected positive emotion of a good shopping experience as a trigger for the merchant to appreciate the cardholder thus reinforcing the positive behavior.

Emotion detection engine may detect a negative mood or emotion or context for response feedback. For example, the response feedback may describe a bad shopping experience. Feedback component 102 may provide data indicating the negative detected mood to merchant system 104 as a trigger for the merchant to rescue the cardholder in an attempt to turn the negative experience into a positive experience.

In some embodiments, based on a detected emotion, feedback audio can be ordered in a review queue to prioritize, for example, negative or extreme emotions. In other examples, the detect emotion can automatically generate a communication to a device, address, phone number, etc. associated with the merchant in the transaction.

In some embodiments, the feedback component can track historical emotions associated with a customer/merchant/transaction class (or combination) and can prioritize feedback for review and/or generate a communication to the merchant based on a deviation from the norm.

Cardholder device 106 may provide biometric data as part of the feedback response, and may include hardware components to collect biometric data. Emotion detection engine may process feedback responses including the biometric data to identify biometric factors as indicators to determine the mood/emotion of the feedback response from the cardholder. Example biometric factors include heart rate, body temperature, brain activity, perspiration rate, blood pressure, facial expression, tone of voice, and so on.

Emotion detection engine may also consider emotion modifiers when detecting emotion, including the current location of the cardholder device 106 and the social environment of the cardholder device 106. For example, social environment considerations include is the person alone, in a small group, in a crowd, driving (i.e. stuck in traffic), walking down a busy street, walking through a park, and so on. Additional emotion modifiers include culture of the cardholder, time of day of the feedback response, personas of the cardholder (e.g. other similar groups of individuals), and so on.

Feedback component 102 may use the detected emotion for the feedback response to determine an appropriate incentive or additional feedback request to encourage transactions at merchants related to the feedback request. This may link the incentive to what the cardholder cares about and is emotional about. Example incentives include deal, discount, prize entry, donations to community, and so on.

Feedback component 102 may provide communications or additional feedback requests (including incentives) in an attempt to alter the mood of the cardholder. For example, if a person is in an average mood at a coffee shop, a recommendation of “why don't you by coffee for the guy behind you?” could be provided to encourage positive “pay it forward” feelings. As another example, two cardholders may be in the same line at a merchant store such as a coffee shop. The second cardholder may be having a bad day as detected from a previous feedback response. The first cardholder may be prompted to buy the other a coffee, brightening the day of both cardholders. Alternately, the merchant could be prompted to buy the cardholder a beverage, reinforcing the emotional connection between the customer and the merchant. Alternately, the feedback component 102 could prompt someone about rewarding volunteer opportunities, and so on.

The position of the feedback data in the queue may be set based on the determined value of the cardholder (frequency, total spend, etc.). This may rank cardholders to prioritize feedback responses, especially feedback responses requesting action by the merchant.

At 216, system 100 notifies the merchant system 104 of received feedback response data via feedback queue or other notification. If the cardholder indicated that they wanted the business management to hear the feedback response right away, then the feedback component 102 sends a notification of the feedback response to one or more devices associated with the merchant system 104. For example, if the voice analysis shows extreme agitation this may trigger an urgent or special recommendation prompt to merchant system 104 for an immediate solution or response. The trigger may be generated based on the emotion detected in the speech signals defining the feedback response and the content of the feedback response.

At 218, the merchant system 104 accesses the provided feedback response data from feedback component 104. The feedback data may include details of the transaction such as a good or service identifier, a date, a time, total price, total amount or an approximate amount to maintain anonymity, and so on. The feedback data may be anonymous. The feedback data may include details of the customer (demographics), details of the customer feedback history, details of the customers shopping history including details that show the customer's value to the business. The customer data may include spend history at that store, spending at any of the merchant's stores, spending in category, and so on. The customer data may include details of the customer's feedback (such as the experience rating, all or a portion of the message transcription, audio recording of the feedback, an indication of emotion/tone).

The cardholder data for loyalty system 114 may include options to provide extra value to the customer, this may include, for example, providing an offer to the customer to rescue them or appreciate their business, providing additional prize entries, providing invitations for special events. The additional response may be automatically triggered based on the feedback response received from the cardholder devices 106.

While viewing the feedback and customer context, at 220, the feedback component 102 may prompt the merchant system 104 to respond to the cardholder device 106 with speech signals, such as for example, “Your customer requested a personal response, Record one now?” Options for feedback responses may include yes, no, or ignore (no received speech signals).

At 222, the business administrator selects to record a message and the feedback component 102 provides a mechanism for recording the merchant's audio message.

At 224, once satisfied with the recording, the feedback component 102 stores it and notifies the cardholder device 106 that a response is waiting. The recording event may also trigger generation and transmission of a rescue offer to cardholder device 106.

In accordance with some embodiments, the feedback component 102 may set up a real-time voice call between merchant system 104 (or a third party customer service call centre for example) and cardholder device 106 if an urgent recommendation prompt is flagged. This automatic and proactive tool may alleviate distressed customers in a timely manner to attempt to rectify or fix a negative transaction related experience. In an aspect, feedback component 102 may provide an active real-time responsive interchange broker for delivery feedback related data exchange between cardholder devices 106 and merchant systems 104. The interchange broker may extend to voice call capabilities to actively facilitate the identification of customer service issues and the response thereto. The notification may include a portion of the information presented in association with the feedback.

In accordance with some embodiments, a cardholder may use cardholder device 106 and speech commands to search out options for contributions made by merchant to charitable organizations based on transactions with cardholder via ACM program. An example exchange of speech signals may be: “Show me stores near me that care”; “Give me directions to the nearest coffee shop on [Loyalty System Name]”; “What merchants have the highest community donation?”; “What is the closest quick-lube with great customer feedback?”; “Where can I shop that will give me extra prize entries?”; “Who has the best deal on new Barbeques?” Or other possible interactions.

Example speech signals may define timely real time negative feedback, “Tell Merchant X that I waited in line for 20 minutes before walking out.”; “Are any community organizations or charities looking for volunteers this afternoon?”.

In accordance with some embodiments, an advertising provider's services may be integrated with a loyalty program having feedback component. The loyalty system 114 is configured to register advertiser provider and register merchant systems 104 for advertisement and feedback mechanism. In this example, survey responses are used to link transactions to advertisements or feedback requests received at cardholder devices 106 by cardholders. An advertising provider may charge the merchant system 104 a fee each time a cardholder device 106 is associated with a transaction (e.g. purchases goods or services) involving a merchant system 104, where the transaction results from an advertisement provided to the cardholder, whether the purchase is made online or offline (i.e. through a “brick and mortar” store). By leveraging one or more of the ACM program features the advertising provider can encourage the feedback mechanism to track that the cardholder device 106 was linked to the advertisement as an intermediate step in the transaction process. The feedback mechanism is described herein, but may for example be a survey that includes a feedback request to identify the means by which it discovered the merchant. If the cardholder device 106 indicates confirmation that it discovered the merchant through an advertisement provided by the advertising provider, the advertising provider may charge a fee to the merchant system 104.

FIG. 4 illustrates a schematic view of a cardholder device 106 and merchant system 104 for exchanging feedback data and transaction data.

Cardholder device 106 includes a processor 502 (as described in relation to feedback component 102) configuring a feedback module 504 connected to feedback component 102 for receiving feedback requests and providing feedback responses. Merchant system 104 also connects to feedback component 102 to receive feedback data and prompts for action, as described. Cardholder device 106 has a location device 506 for tracking and generating location data which in turn generate location events to trigger feedback requests.

Cardholder device 106 initiates transactions with merchant system 104 via a transaction token 510 configured with financial data. The financial data may include default credit card information and authorization, for example. Transaction data signals are exchanged via near field communication (NFC) devices 518, 522 to execute the transaction for goods or services. Cardholder device 106 may provide a virtual wallet for cardholder and provide the vehicle for the transaction via tokenization. This enables the cardholder to directly transact with the merchant. This may reduce overhead transaction costs. Transaction processor 524 processes the transaction between cardholder device 106 and merchant system 104 to generate a transaction notification for transmission to transaction notification system 108. Transaction details may be stored in data store 508, 520. Data store 508, 520 may be any type of electronic memory that is located either internally or externally such as, for example, RAM, ROM, CDROM, electro-optical memory, magneto-optical memory, EPROM, and EEPROM, FRAM or the like.

Network interface 526 enables cardholder device 106 to communicate with other networks, to access and connect to network resources such as feedback component 102, to serve an application, to access other applications, and perform other computing applications by connecting to a network such as network 110.

I/O interface 512 enables cardholder device 106 to interconnect with input and output devices, e.g., peripheral devices or external storage devices. Such peripheral devices may include one or more input devices, such as a keyboard, mouse, camera, touch screen and a microphone, and may also include one or more output devices such as a display screen (with three dimensional capabilities) and a speaker.

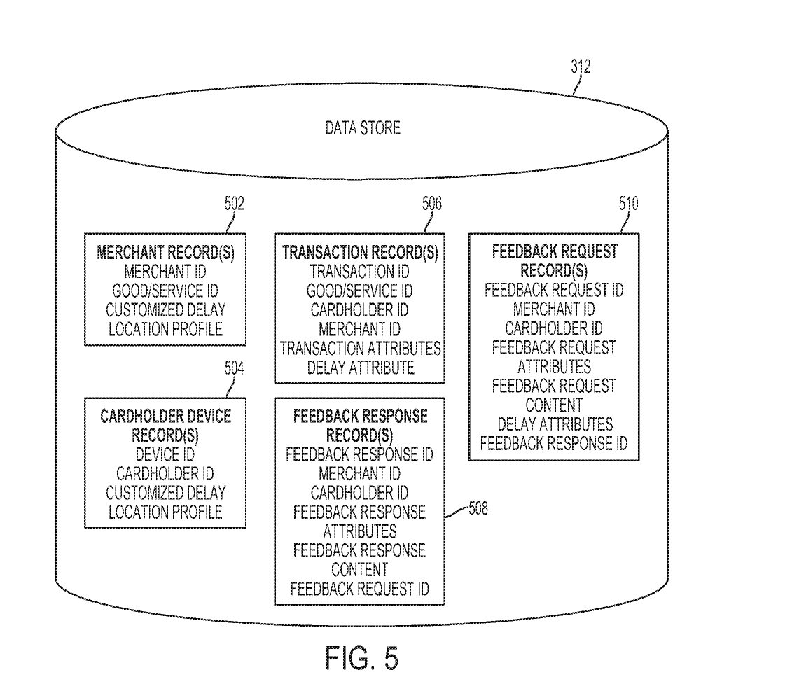

FIG. 5 illustrates a schematic view of a data store 312 of records for the feedback component 102 according to some embodiments.

Feedback component 102 may store merchant records 502 relating to merchant system 104 for data collected from transactions, feedback requests, feedback responses, and so on. Merchant record 502 may include a merchant identifier uniquely identifying a merchant system 104 to link merchant to other data records. Merchant records 502 may include good and service identifiers uniquely identifying various goods and services linked to merchant. The goods and services may link to transactions by cardholder devices 106 when goods and services purchased. The goods and services may link to feedback by cardholder devices 106 when feedback response is received identifying goods and services. Merchant records 502 may include customized delay data to configure delivery notification delays for merchant system 104. Merchant records 502 may include one or more location profiles for merchant store locations.

Feedback component 102 may store cardholder device records 504 relating to cardholder devices 106 for data collected from transactions, feedback responses, and so on. Cardholder device records 504 may include device identification data to identify various cardholder devices 106 to link to feedback responses, transactions, and so on. Cardholder device records 504 may include cardholder identification data to identify cardholders for the loyalty program. Cardholder device records 504 may include customized delay data to configure delivery notification delays for cardholder devices 106. Cardholder device records 504 may include one or more location profiles for location data collected by tracking location of cardholder devices 106.

Feedback component 102 may store transaction records 506 for data collected from transactions. Transaction records 506 may include transaction identification data to identify transactions for goods and services between merchant systems 104 and cardholder devices 106. Transaction records 506 may include good and service identification data to identify goods and services of transactions between merchant systems 104 and cardholder devices 106. Delivery notification delays may vary depending on the good and service which may be identified via the good and service identification data. Transaction records 506 may include cardholder device 106 identification data to identify cardholder devices 106 associated with the transactions. Transaction records 506 may include merchant system 104 identification data to identify merchant systems 104 associated with the transactions. Transaction records 506 may include transaction attributes such as item cost, total cost, date, time, location, goods, services, and so on. Transaction records 506 may include delay attributes that are used to calculate an appropriate delivery notification delay for the feedback request.

Feedback component 102 may store feedback request records 510 for data defining feedback requests. Feedback request records 510 may include feedback request identification data to identify feedback request data. Feedback request records 510 may include cardholder device 106 identification data to identify cardholder devices 106 associated with the feedback requests (e.g. cardholder devices 106 that have received particular feedback requests). Feedback request records 510 may include merchant system 104 identification data to identify merchant systems 104 associated with the feedback requests (e.g. particular merchants may use particular feedback requests). Feedback request records 510 may include feedback request attributes such as time, date, format, language. Feedback request records 510 may include feedback request content used to generate feedback request speech signals. Feedback request records 510 may include delay attributes that are used to calculate an appropriate delivery notification delay for the feedback request. Feedback request records 510 may include feedback response identification data to identify different feedback responses received in response to a feedback request to link feedback responses to feedback requests.

Feedback component 102 may store feedback response records 508 relating to for data collected as feedback responses. Feedback response records 508 may include feedback response identification data to identify feedback response data. Feedback response records 508 may include cardholder device 106 identification data to identify cardholder devices 106 associated with the feedback response (e.g. cardholder devices 106 that generated particular feedback responses). Feedback response records 508 may include merchant system 104 identification data to identify merchant systems 104 associated with the feedback response (e.g. particular merchants may be the subject of particular feedback responses). Feedback response records 508 may include feedback response attributes such as time, date, language, emotion detected, context. Feedback response records 508 may include feedback response content generated by processing feedback response speech signals. Feedback response records 508 may include feedback request identification data to identify different feedback requests that the feedback response was received in response to. The feedback response identification data links feedback requests to feedback responses.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only. The scope is indicated by the appended claims.

What is claimed is:

1. A network communication system for managing feedback communications, the system comprising:
one or more merchant systems, each merchant system comprising a transaction processing device for triggering transmission of a transaction notification alert, and a location device for generating and transmitting location data for the one or more merchant systems;
a transaction notification system for collecting transaction notification alerts from the one or more merchant systems and transmitting a transaction notification data feed compiling the collected transaction notification alerts;
one or more cardholder devices configured to receive and process speech signals for feedback requests and generate speech signals for feedback responses, wherein the cardholder devices comprise location detection hardware for generating location data for the one or more cardholder devices;
a feedback component comprising:
text to speech processor for generating the speech signals for the feedback requests using feedback request data records;
speech to text processor for generating feedback response data records by transforming the speech signals for feedback responses received from the one or more cardholders devices;
notification management processor for managing transmissions of the speech signals for feedback requests by determining, for each feedback request, a respective delivery notification delay;
a transceiver for transmitting and receiving the feedback request data records and the feedback response data records, wherein the transceiver transmits a portion of the feedback request data records or the speech signals for feedback requests after expiration of the respective determined delivery delay in response to a location notification;
a network interface for connecting to the one or more merchant systems, one or more cardholder devices and the transaction notification system for data exchange; and
location tracking hardware for correlating the location data for the one or more cardholder devices to the location data for the one or more merchant systems to generate the location notification to trigger the transmission of the speech signals for feedback requests; and
one or more data stores for storing feedback request data records and the feedback response data records.

2. The network communication system of claim 1, wherein the notification management processor configures a trigger handler to establish a trigger condition which when satisfied, triggers the transmission of the speech signals for feedback requests.

3. The network communication system of claim 1, wherein the location notification is triggered when the location data includes data indicating that the one or more cardholder devices has paired with a vehicle device or an electric charger.

4. The network communication system of claim 1, wherein the one or more cardholder devices are configured to transmits signals to trigger the location notification when a transportation or map application is accessed on the one or more cardholder devices.

5. The network communication system of claim 1, wherein the location notification is triggered when the location data includes data indicating that the one or more cardholder devices is travelling over a threshold speed, or data indicating that the location of the one or more cardholder devices is further from a location indicated by the location data for the one or more merchant systems than a threshold distance.

6. The network communication system of claim 1, wherein the respective delivery notification delay is based on transaction data corresponding to the respective transaction notification alert.

7. The network communication system of claim 6, wherein the respective delivery notification delay is based at least in part on an identifier identifying a product or service, or a class of the product or service associated with the electronic transaction.

8. The network communication system of claim 6, wherein the respective delivery notification delay is based at least in part on timing information in a feedback history of a customer profile.

9. A method for managing feedback communications in a network of computing resources, the method comprising:
receiving, by at least one processor, at least one transaction communication, the at least one transaction communication including data associated with an electronic transaction involving a payment identifier associated with a customer profile;
initiating signals to cause a trigger handler to establish a trigger condition for initiating a feedback acquisition based on the data associated with the electronic transaction; and
upon detection of the trigger condition, initiating signals to cause an input device to receive feedback input.

10. The method of claim 9, wherein the trigger condition is satisfied when at least one processor on a mobile communication device associated with the customer profile receives signals indicating that a location of the mobile communication device is leaving a location associated with the electronic transaction.

11. The method of claim 10, wherein the signals indicating that the location of the mobile communication device is leaving include: signals indicating that the mobile communication device has paired with a vehicle device or an electric charger.

12. The method of claim 10, wherein the signals indicating that the location of the mobile communication device is leaving include: signals indicating that the mobile communication device has accessed a transportation or map application.

13. The method of claim 10, wherein the signals indicating that the location of the mobile communication device is leaving include: signals from a hardware location device indicating that the mobile communication device is travelling over a threshold speed, or that the location of the mobile communication device is further from the location associated with the electronic transaction than a threshold distance.

14. The method of claim 9, wherein the trigger condition is satisfied when a feedback acquisition delay has elapsed, the feedback acquisition delay based on at the data associated with the electronic transaction.

15. The method of claim 14, wherein the feedback acquisition delay is based at least in part on an identifier identifying a product or service, or a class of the product or service associated with the electronic transaction.

16. The method of claim 14, wherein the feedback acquisition delay is based at least in part on timing information in a feedback history of the customer profile.

17. The method of claim 9, comprising: generating with a text to speech processor request signals representing request audio for communicating one or more feedback requests on an audio output device of a mobile device associated with the customer profile; receiving feedback signals representing feedback audio received at an audio input device of the mobile device associated with the customer profile, and storing the speech signals on a data storage device.

18. The method of claim 17, comprising: determining, with the at least one processor, an emotion associated with the feedback audio based on the feedback signals; and
ordering the feedback audio in a review queue based on the determined emotion.

19. The method of claim 17, comprising: generating response signals representing response audio for communicating a recorded audio response to the feedback audio to the mobile device associated with the customer profile.

20. A non-transitory, computer readable medium or media having stored thereon computer-interpretable instructions which when executed by at least one processor, configure the at least one processor for:
receiving at least one transaction communication, the at least one transaction communication including data associated with an electronic transaction involving a payment identifier associated with a customer profile;
initiating signals to cause a trigger handler to establish a trigger condition for initiating a feedback acquisition based on the data associated with the electronic transaction; and
upon detection of the trigger condition, initiating signals to cause an input device to receive feedback input.
